(19) United States
(12) Patent Application Publication
(10) Pub. No.: US 2025/0211414 A1
(43) Pub. Date: Jun. 26, 2025

(54) AN AREA AND POWER EFFICIENT CLOCK DATA RECOVERY (CDR) AND ADAPTATION IMPLEMENTATION FOR DENSE WAVELENGTH-DIVISION MULTIPLEXING (DWDM) OPTICAL LINKS

(71) Applicant: XILINX, INC., San Jose, CA (US)

(72) Inventors: Chi Fung POON, Sunnyvale, CA (US); Shih-Wei CHOU, San Jose, CA (US); Mayank RAJ, San Jose, CA (US); Parag UPADHYAYA, Los Gatos, CA (US); Huy NGO, San Jose, CA (US); Weisheng Winson LIN, San Francisco, CA (US)

(21) Appl. No.: 18/394,668

(22) Filed: Dec. 22, 2023

(51) Int. Cl. H04L 7/00; H04L 1/00; H04L 7/02

(52) U.S. Cl. CPC H04L 7/0079; H04L 1/0071; H04L 7/02

(57) ABSTRACT

Embodiments herein describe techniques for area and power efficient clock data recovery (CDR) and adaptation implementations for dense wavelength-division multiplexing (DWDM) optical links and other types of links. One example is a system that includes a plurality of receiver circuits that sample signals based on respective receiver clocks, where the receiver circuits include a reference receiver circuit and remaining receiver circuits, and where the receiver clock of the reference receiver circuit comprises a reference clock. The system further includes a clock and data recovery (CDR) circuit that controls a phase of the reference clock based on outputs of the reference receiver circuit, and time-multiplexed de-skew circuitry configured to determine time-multiplexed phase offsets for the remaining receiver circuits based on time-multiplexed outputs of the remaining receiver circuits, where the remaining receiver circuits phase-shift the reference clock based on the respective time-multiplexed phase offsets to provide the respective receiver clocks.

### TECHNICAL FIELD

Examples of the present disclosure generally relate to communication systems, including area and power efficient clock data recovery (CDR) and adaptation implementations for dense wavelength-division multiplexing (DWDM) optical links.

### BACKGROUND

There is a demand for high-bandwidth, low power, and small form factor communication links. Dense wavelength-division multiplexing (DWDM) permits multiple, closely spaced carriers to be transmitted over a single fiber. DWDM may thus satisfy high-bandwidth demands. Associated optical components and electrical circuitry, such as clock and data recovery (CDR) circuitry, may be targeted for improvements in power consumption and form factor (i.e., area requirements).

### SUMMARY

Techniques for area and power efficient clock data recovery (CDR) and adaptation implementations for dense wavelength-division multiplexing (DWDM) optical links are described. One example is a system that includes a plurality of receiver circuits that sample signals based on respective receiver clocks, where the receiver circuits include a reference receiver circuit and remaining receiver circuits, and where the receiver clock of the reference receiver circuit comprises a reference clock. The system further includes a clock and data recovery (CDR) circuit that controls a phase of the reference clock based on outputs of the reference receiver circuit, and time-multiplexed de-skew circuitry configured to determine time-multiplexed phase offsets for the remaining receiver circuits based on time-multiplexed outputs of the remaining receiver circuits, where the remaining receiver circuits phase-shift the reference clock based on the respective time-multiplexed phase offsets to provide the respective receiver clocks.

Another example described herein is method that includes extracting data from a plurality of signals with respective receiver circuits based on respective receiver circuit clocks, where the receiver circuits include reference receiver circuit and remaining receiver circuits, and where the receiver clock of the reference receiver circuit is a reference clock. The method further includes controlling a frequency of the reference clock based on outputs of the reference receiver, determining time-multiplexed phase offsets for the remaining receiver circuits based on time-multiplexed outputs of the remaining receiver circuits, and phase-shifting the reference clock for the remaining receiver circuits based on the respective phase offsets to provide the respective receiver clocks.

Another example described herein is a system that includes first and second integrated circuit (IC) devices. The first IC device includes a plurality of receiver circuits and a clock and data recovery (CDR). The receiver circuits sample signals based on respective receiver clocks, and include a reference receiver circuit and remaining receiver circuits. The receiver clock of the reference receiver circuit is a reference clock. The CDR system includes a CDR circuit that controls a phase of the reference clock based on outputs of the reference receiver circuit. The CDR system further includes time-multiplexed de-skew circuitry that determines time-multiplexed phase offsets for the remaining receiver circuits based on time-multiplexed outputs of the remaining receiver circuits. The remaining receiver circuits phase-shift the reference clock based on the respective time-multiplexed phase offsets to provide the respective receiver clocks. The second IC device receives the outputs of the receiver circuits.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 is a block diagram of a system that includes a multi-channel receiver system, according to an embodiment.

FIG. 2 is a block diagram of the receiver system, according to an embodiment.

FIG. 3 is a block diagram of a receiver circuit of the receiver system, according to an embodiment.

FIG. 4 is a block diagram of clock and data recovery system, according to an embodiment.

FIG. 5 illustrates a timing diagram for a clock domain crossing circuit of the receiver system, according to an embodiment.

FIG. 6 is another block diagram of the clock and data recovery system, according to an embodiment.

FIG. 7 illustrates a method, according to an embodiment.

FIG. 8 is another block diagram of the receiver system, according to an embodiment.

FIG. 9 is a block diagram of configurable circuitry, including an array of configurable or programmable circuit blocks or tiles, according to an embodiment.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe area and power efficient clock data recovery (CDR) and adaptation implementations for dense wavelength-division multiplexing (DWDM) optical links.

A DWDM transmitter multiplexes a plurality of optical signals having different wavelengths, onto an optical fiber. A DWDM receiver de-multiplexes the optical signals, converts the optical signals to electrical signals, and extracts data from the electrical signals in respective receive channels. The receive channels include respective clock and data recovery (CDR) circuits that recover data sampling clocks from the respective electrical signals, and respective calibration circuits that calibrate channel-specific parameters (e.g., offsets, slicing thresholds, equalization coefficients, and/or other parameters). The CDR and calibration circuits consume substantial amounts of power and area.

Since wavelengths of the multiplexed signals are transmitted by the same transmitter reference clock, frequency offsets between transmitted data and a reference clock of the receiver are the same for all of the signals. In addition, since channel-specific parameters tend to be static or slowly changing, a calibration loop bandwidth requirement is relatively low.

As disclosed herein, the synchronous nature of the multiplexed signals and the relatively low bandwidth requirement of the calibration loop are exploited to provide a low power, small form factor, high-bandwidth receiver system that shares a CDR system amongst multiple receive channels in a time-interleaved fashion. The shared CDR system may be placed (i.e., physically positioned within an IC design or die) in a common region of the receiver (e.g., a region that is equidistant or equally accessible to the receive channels), to increase channel density, which may increase throughput per unit area.

The shared CDR system includes a reference CDR circuit that performs CDR based on outputs of a reference one of the channels, to lock a frequency of a reference clock to a frequency of the extracted data. The reference channel extracts data from one of the signals based on a phase and frequency of the reference clock, and provides the extracted data, error data, and the reference clock to the reference CDR circuit. The reference channel may be selectable or programmable, which may provide flexibility and/or improve yield.

Although frequency offsets between the transmitted data and the reference clock of the receiver are the same for all of the signals, phases of the transmitted data may differ amongst the signals. Moreover, the phase offsets may drift over time. The shared CDR system further includes time-interleave de-skew circuitry that determines the phase offsets for remaining receive channels in a time-interleaved manner. The remaining receive channels phase-shift the reference clock based on respective phase offset codes to provide respective channel-specific reference clocks, and extract data from respective signals based on the channel-specific reference clocks. Although the phase offsets may drift over time, the drift is relatively slow. Time-interleaved phase offsets have little or no impact on bit error rate (BER), provided that the adaptation loop bandwidth of the time-interleave de-skew circuitry is less than a time-interleaved frequency. The shared CDR system thus tracks based on the reference channel and adjust phases of remaining (enabled) channels. The absence of channel-specific CDR circuits reduced power consumption and form factor.

The shared CDR system may further include time-interleave calibration circuitry that determines channel-specific parameters for the receive channels in a time-interleaved manner.

The receiver system may limit or restrict operations to enabled ones of the receive channels, which may reduce power consumption.

Receiver circuits of the receive channels may operate at a relatively high speed (e.g., gigabit rate). The receiver circuits may output serial data, and the receiver system may include de-serializer circuitry that permits the shared CDR system to operate at a significantly lower frequency than the receiver circuits, which may further reduce power consumption. The de-serializer circuitry may de-serialize in stages, reducing speed with each stage. As an example, and without limitation, the de-serializer circuitry may convert outputs of the receive channels to 32 or 54 bits.

The receiver system may further include parallel physical (PHY) circuitry that outputs the de-serialized data and clocks of the receive channels to other circuitry (e.g., a compute block) and/or to another device (e.g., chip or chiplet).

The receiver system may be used for optical signals, electrical signals received over a wire link, and/or wireless signals converted to electrical signals.

The receiver system may be used for chip-to-chip (C2C) communications (e.g., photonic, electrical, and/or wireless). For example, and without limitation, the receiver system may be provided on a first chiplet that connects to a second chiplet (e.g., a compute chiplet) via a C2C PHY. The first chiplet and/or the second chiplet may include a field-programmable gate array (FPGA).

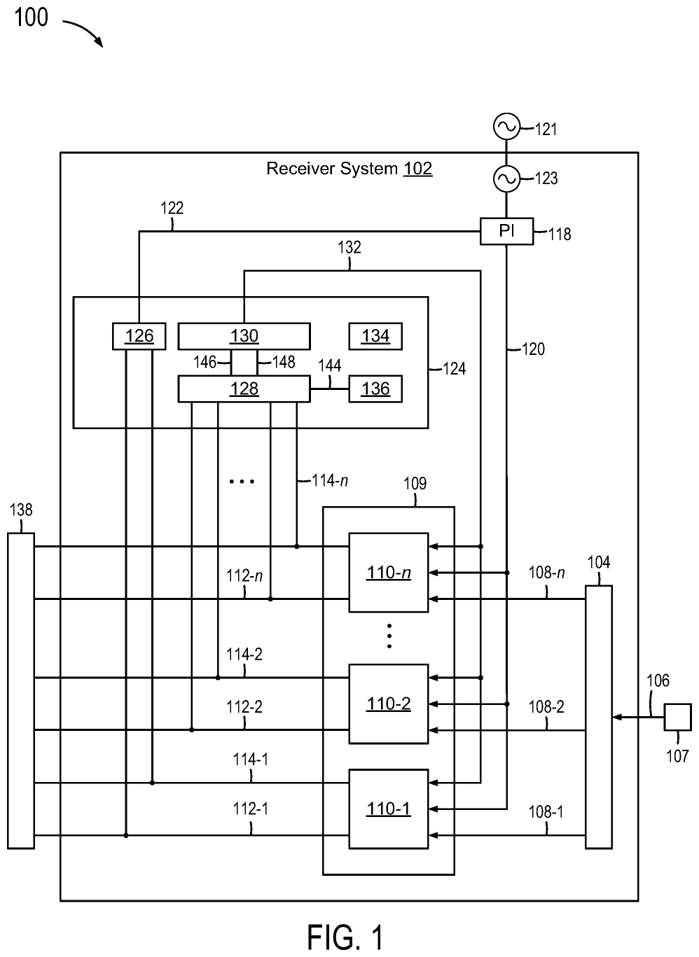

FIG. 1 is a block diagram of a system 100 that includes a multi-channel receiver system (receiver system) 102, according to an embodiment. Receiver system 102 includes de-multiplexer circuitry 104 that de-multiplexes a plurality of signals from a multi-channel signal 106 received from a transmitter 107. Receiver system 102 outputs the de-multiplexed signals as electrical signals 108-1 through 108-n (collectively, signals 108), where n is a positive integer greater than 1.

Signal 106 may include a plurality of optical carrier signals having different wavelengths, multiplexed by transmitter 107 onto an optical fiber in accordance with a wavelength-division multiplexing (WDM) scheme. The optical carrier signals may be multiplexed with relatively dense spacing in accordance with a dense wavelength-division multiplexing (DWDM) scheme. Alternatively, signal 106 may include a plurality of electrical carrier signals multiplexed over a wire and/or a wireless channel (e.g., a radio frequency channel).

Receiver system 102 further includes a block 109 of receiver circuits 110-1 through 110-n (collectively, receiver circuits 110) that output data 112-1 through 112-n (collectively, data 112) from signals 108-1 through 108-n based on respective receiver clocks 114-1 through 114-n. Data 112 includes data extracted from signals 108, and may further include error data, such as described further below. Receiver circuits 110 may output extracted data and error data on respective data and error busses. Receiver circuits 110 represent portions of respective channels of receiver system 102. The terms “receiver circuits” and “channels” may be used interchangeably herein.

In an embodiment, one of receiver circuits 110 serve as a reference receiver that uses reference clock 120 as a receiver clock. In the example of FIG. 1, receiver circuit 110-1 serves as the reference receiver that extracts data 112-1 using reference clock 120 as receiver clock 114-1. As described further below, the reference receiver may be selectable from amongst receiver circuits 110. In FIG. 1, data 112 and receiver clock 114 of the reference receiver is denoted reference data 142 and reference receiver clock 140. Reference receiver clock 140 corresponds to reference clock 120.

Receiver system 102 further includes a phase interpolator (PI) 118 that controls a frequency and a phase (i.e., performs phase rotation) of reference clock 120 based on a PI code 122. Receiver system 102 may generate reference clock 120 based on a source clock 121. Receiver system 102 may include a local oscillator 123 (e.g., an injection-locked oscillator) that generates reference clock 120 based on source clock 121.

Receiver system 102 further includes a clock and data recovery (CDR) system 124. CDR system 124 includes a reference CDR circuit 126 that determines PI code 122 based on reference data 142 and reference receiver clock 140. Reference CDR circuit 126 may control PI code 122 such that a frequency of reference clock 120 tracks (i.e., is equal to) a frequency of a reference clock of transmitter 107 (e.g., to maintain a constant or steady offset between the frequencies of reference clock 120 and the reference clock of transmitter 107, which may be zero). Reference CDR circuit 126 may control PI code 122 such that the reference receiver circuit 110 samples the corresponding signal 108 at a maximum eye opening.

An eye opening is a relatively unobstructed central region of an eye diagram or eye pattern (i.e., a graphical representation) of an electrical or optical communication signal. A width of the eye opening defines a time interval over which the signal can be sampled without error from inter-symbol interference (ISI). A time at which the eye opening is widest may represent a desired or optimum sampling time. A height of the eye opening, at a specified sampling time, defines a margin over noise. A rate of closure of the eye indicates sensitivity to timing error. The quality of the signal (e.g., the amount of inter-symbol interference (ISI), noise, and jitter) can be judged from the appearance of the eye. An eye pattern may be used to estimate bit error rate (BER) and signal-to-noise ratio (SNR).

Reference CDR circuit 126 may employ one or more of a variety of techniques. Reference CDR circuit 126 may include, for example and without limitation, a phase detector that determines an instantaneous phase difference between reference clock 120 and data 112 of the reference receiver circuit 110. Reference CDR circuit 126 may further include a first order phase path, or loop, that tracks the instantaneous phase difference. Reference CDR circuit 126 may further include a second order path that periodically updates the first order path. The second order path may track, average, and/or integrate the instantaneous phase difference over time.

Where signals 108-1 through 108-n are transmitted from the same transmitter (e.g., over the same optical fiber or cable) based on a reference clock of transmitter 107, the frequencies of signals 108-1 through 108-n are equal to one another (i.e., frequency offsets of signals 108-1 through 108-n, relative to a reference clock of transmitter 107, are equal to one another). Thus, instead of providing an additional instance of reference CDR circuit 126 for each of the remaining receiver circuits 110, the remaining receiver circuits 110 may utilize reference clock 120 (i.e., a shared CDR loop for ppm tracking).

Phases of signals 108 may, however, differ from one another (e.g., due to various/differing delays). If the remaining receiver circuits 110 sample the respective signals 108 at the same phase of reference clock 120 used by the reference receiver circuit 110, the remaining receiver circuits 110 may not capture data accurately. CDR system 124 further includes de-skew circuitry that tracks or determines phase offsets of the remaining receiver circuits, relative to reference clock 120. The remaining receiver circuits 110 phase-shift reference clock 120 based on respective phase offsets to provide respective phase-appropriate receiver clocks 114. The remaining receiver circuits 110 may then sample the respective signals 108 based on the phase-appropriate receiver clocks 114. Receiver system 102 may determine the phase offsets in a time-interleaved manner, such as described below.

In FIG. 1, CDR system 124 further includes time-interleaving circuitry 128 that time-interleaves the outputs of receiver circuits 110, based on a ch_sel control 144. As an example, during a first time interval, time-interleaving circuitry 128 may output data 112-1 and receiver clock 114-1 as internal data 146 and internal clock 148. During subsequent time intervals, time-interleaving circuitry 128 may provide outputs of respective receiver circuits 110-2 through 110-2 as internal data 146 and internal clock 148. Time-interleaving circuitry 128 may repeat the foregoing procedure over time.

CDR system 124 further includes time-interleaved de-skew circuitry 130 that tracks or determines time-interleaved phase offsets 132 for the remaining receiver circuits 110 based on internal data 146 and internal clock 148 of the remaining receiver circuits 110. Time-interleaved de-skew circuitry 130 may be similar or identical to a phase path of reference CDR circuit 126. with relatively little or no BER penalty. Where the phase offsets are relatively static or drift relatively slowly over time (as is typical), the remaining receiver circuits 110 may extract data 112 from respective signals 108 with little or no BER penalty. A time-interleave frequency of the time-interleaving circuitry may be higher than a de-skew loop bandwidth to avoid BER degradation

Sharing reference CDR circuit 126 amongst receiver circuits 110, in combination with time-interleaved de-skew circuitry 130 (i.e., hardware sharing) may be useful to reduce area and/or power consumption of receiver system 102, relative to a receiver system that uses separate CDR circuitry for each channel. CDR system 124 may be placed (i.e., physically positioned) in a region of an integrated circuit die/chip that is central to (i.e., approximately equidistant from) receiver circuits 110.

Since phases of receiver clocks 114 may differ from one another, time-interleaving may raise clock domain-crossing issues. For example, glitches may arise on internal data 146 during channel transitions (i.e., when ch_sel control 144 transitions receiver channels). To avoid clock domain-crossing issues, receiver system 102 may further include clock domain crossing (CDC) circuitry 134 that manages transitions between time domains during channel transitions. CDC circuitry 134 may, for example, disable time-interleaving circuitry 128 and/or time-interleave de-skew circuitry 130 during channel transitions.

Receiver system 102 further includes control circuitry 136 that manages channel transitions, such as described further below. Control circuitry 136 may include, for example and without limitation, a finite state machine (FSM).

System 100 may further include data processing circuitry 138 that receives data 112 and receiver clocks 114.

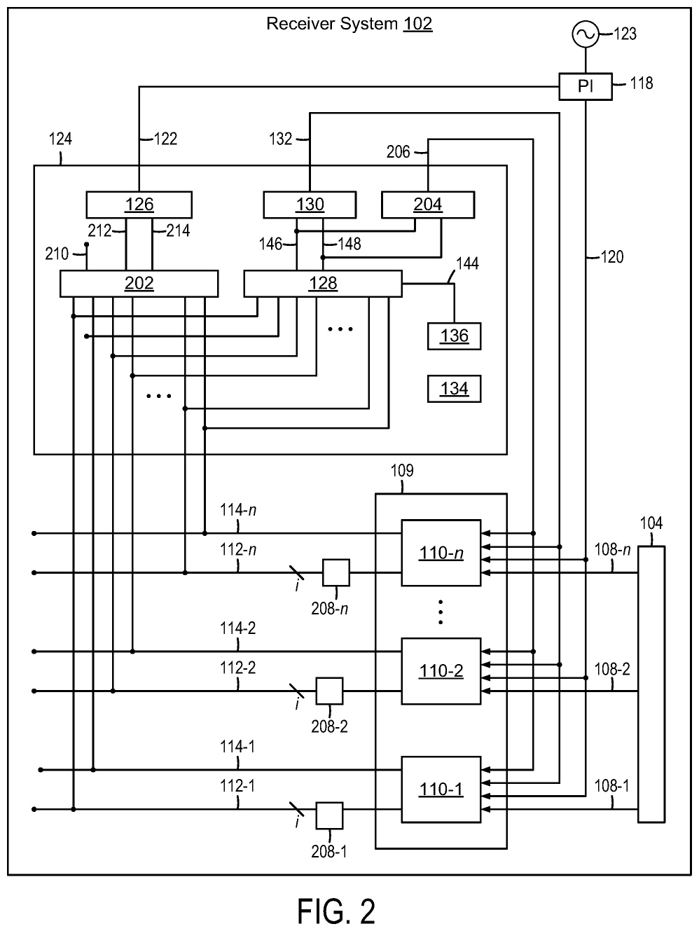

System 100 may further include a transmitter system that transmits data from data processing circuitry 138. The transmitter system and receiver system 102 may be provided as a high-speed serial interface, such as a gigabit transceiver (GT). Such a GT may be included as part of a computing platform (e.g., an IC die or chip, an IC board, and/or other IC device), which may include configurable/programmable logic. System 100 and/or receiver system 102 may include one or more additional features, examples of which are provided below with reference to FIG. 2.

FIG. 2 is a block diagram of receiver system 102, according to an embodiment. In the example of FIG. 2, receiver system 102 includes reference channel selection circuitry 202 that provides data 112 and receiver clock 114 of a selectable one of receiver circuits 110 (i.e., the reference receiver circuit) to reference CDR circuit 126, as reference channel data 212 and reference channel clock 214, based on ref_sel control 210. The Receiver system 102 may further include programmable logic that controls ref_sel control 210. Selecting one of multiple receiver channels as a reference channel for frequency offset tracking provides flexibility and may improve yield.

In FIG. 2, receiver system 102 further includes time-interleave calibration circuitry 204 that determines time-interleaved parameters 206 for receiver circuits 110 in a time-interleaved manor. Time-interleaved calibration circuitry 204 may output time-interleaved parameters 206 as digital codes. Time-interleaved parameters 206 may include adaptive parameters for variables/functions that may change over time. Time-interleaved parameters 206 may further include static parameters for variables/functions that generally do not vary over time. Time-interleaved calibration circuitry 204 may determine static parameters on power-up of receiver system 102, and may determine adaptive parameters in an ongoing manner. Example time-interleaved parameters 206 are provided further below.

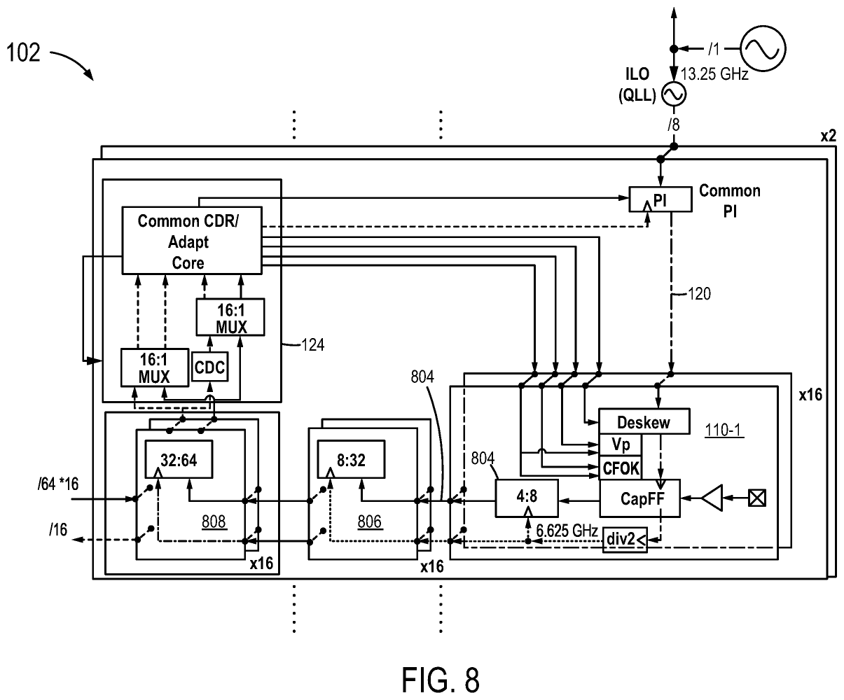

Receiver system 102 may further include de-serializer circuitry 208-1 through 208-n (collectively, de-serializer circuitry 208) that de-serializes output data of receiver circuits 110 to provide data 112 as de-serialized data. De-serializer circuitry 208 may be part of a serializer/de-serializer (SERDES) interface. De-serializer circuitry 208 may de-serialize data 112 in stages. De-serializing output data of receiver circuits 110 may permit CDR system 124 to operate at a lower speed, which may reduce power consumption. De-serializer circuitry is described further below with reference to FIG. 8.

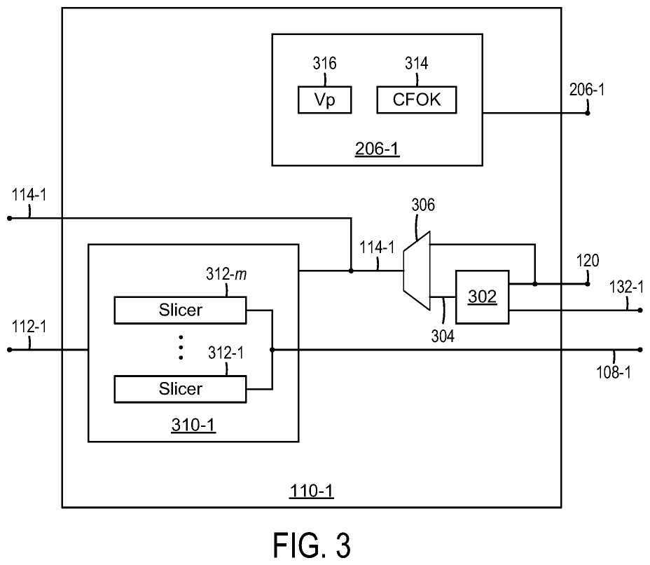

FIG. 3 is a block diagram of receiver circuit 110-1, according to an embodiment. Remaining receiver circuits 110-2 through 110-n may be similar or identical to receiver circuit 110-1. In the example of FIG. 3, receiver circuit 110-1 includes de-skew circuitry 302-1 that shifts a phase of reference clock 120 based on a time-interleaved phase offset 132-1 determined for receiver circuit 110-1 (i.e., when receiver circuit 110-1 is not the reference receiver circuit), to provide a phase-adjusted reference clock 304-1.

Receiver circuit 110-1 further includes clock multiplexing circuitry 306-1 that outputs reference clock 120 as receiver clock 114-1 when receiver circuit 110-1 is the reference receiver circuit, and outputs phase adjusted reference clock 304-1 as receiver clock 114-1 when receiver circuit 110-1 is not the reference receiver circuit.

Receiver circuit 110-1 further includes data capture circuitry 310-1 that extracts data 112-1 based on signal 108-1, receiver clock 114-1, and time-interleaved parameters 206-1 determined for receiver circuit 110-1. Data capture circuitry 310-1 may include one or more slicer circuits 312-1 through 312-m (collectively, slicer circuits 312), illustrated here as data capture flip-flops (CapFFs) that capture voltage levels of signal 108-1 based on receiver clock 114-1.

In an embodiment, a first subset of slicer circuits 312 are used for data sampling (i.e., data slicers) and a second subset of slicer circuits 312 are used for error sampling (i.e., error slicers). As an example, and without limitation, the first subset of slicer circuits 312 may include four data slicers that sample signal 108-1 at different phases of receiver clock 114-1. The second subset may include a signal error slicer, which may generate error data based on a difference between a voltage of signal 108-1 and a reference level (e.g., estimated or predicted signal levels). The reference level may be based on a time-interleaved parameter 206-1 as described further below. In another example, the first and second subsets include equal numbers of data slicer and error slicers. Using fewer error slicers than data slicer may reduce power consumption, and any reduction of bandwidth may be compensated for with gain in CDR system 124.

In the example of FIG. 3, time-interleaved parameters 206-1 include a CFOK code 314-1 and a peak voltage (Vp) code 316-1. Data capture circuitry 310-1 may use CFOK code 314-1 for offset cancelation in slicer circuits 312. For example, a CapFF may include p-type and n-type devices. Offset between the p-type and n-type devices determine the eye opening for signal 108-1. In order to improve BER, the p-type device or the n-type may be biased to compensate for a mismatch condition (i.e., offset cancellation) based on CFOK code 314-1. In an example, the mismatch condition is static and time-interleaved calibration circuitry 204 determines CFOK codes for receiver circuits 310 once (e.g., on power-up of receiver system 102), in a time-interleaved fashion.

Vp code 316-1 identifies a location of a peak voltage of an eye of signal 108-1 (i.e., a slicing level for deciding whether a sample represents a one or a zero). One of slicer circuits 312 may be dedicated to peak voltage detection. Data capture circuitry 310-1 may use Vp code 316 to control times at which data slicers sample signal 108-1. Data capture circuitry 310-1 may also use Vp code 316 to set a reference voltage level for an error slicer.

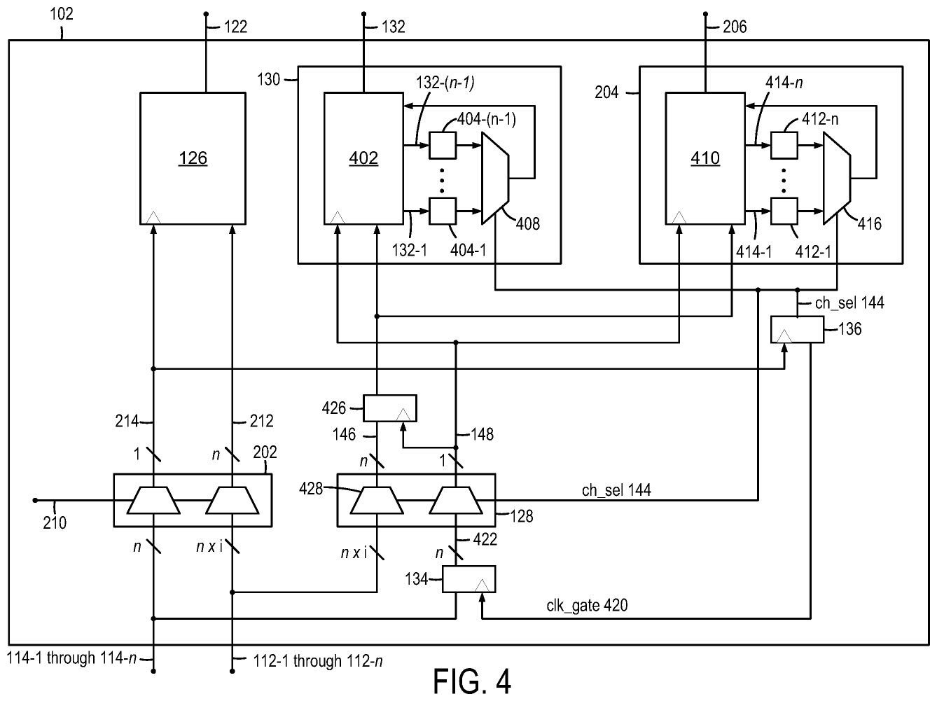

FIG. 4 is a block diagram of CDR system 124, according to an embodiment. In FIG. 4, time-interleave de-skew circuitry 130 includes a de-skew circuit 402 that determines time-interleaved phase offsets 132, such as described further above. In FIG. 4, time-interleaved phase offsets 132 are denoted 132-1 through 132-(n−1) to illustrate that de-skew circuit 402 determines time-interleaved phase offsets 132 for all but the reference receiver. Time-interleave de-skew circuitry 130 further includes registers 404-1 through 404-(n−1) that store time-interleaved phase offsets 132-1 through 132-(n−1) determined for respective receiver circuits 110.

Time-interleave de-skew circuitry 130 further includes multiplexer circuitry 408. When a channel is selected by ch_sel control 144, multiplexer circuitry 408 returns the time-interleaved phase offset 132 for the selected channel, from the respective register 404 to time-interleave de-skew circuitry 130. Saving the time-interleaved phase offsets determined for the respective channels enhance efficiency of time-interleave de-skew circuitry 130.

In FIG. 4, time-interleave calibration circuitry 204 includes calibration circuitry 410 that determines time-interleaved parameters 206, such as described further above. Time-interleave calibration circuitry 204 further includes registers 412-1 through 412-(n−1) that store time-interleaved parameters 206 determined for respective receiver circuits 110.

Time-interleave calibration circuitry 204 further includes multiplexer circuitry 416. When a channel is selected by ch_sel control 144, multiplexer circuitry 416 returns the time-interleaved parameter(s) for the selected channel, from the respective register 412 to time-interleave calibration circuitry 204. Saving the time-interleaved parameter(s) determined for the respective channels enhance efficiency of time-interleave calibration circuitry 204.

Further in the example of FIG. 4, CDC circuitry 134 gates receiver clocks 114 based on a clk_gate control 420 from control circuitry 136. In this example, control circuitry 136 uses clk_gate control 420 to disable CDC circuitry 134 during transitions of ch_sel control 144, and thus pause receiver clocks 114 during channel transitions.

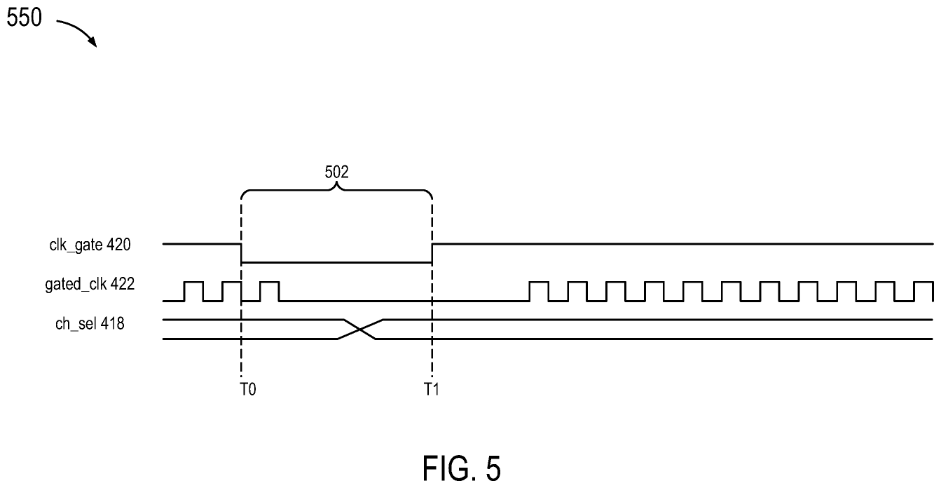

FIG. 5 illustrates a timing diagram 500 for CDC circuitry 134, according to an embodiment. In FIG. 5, control circuitry 136 de-activates clk_gate control 420 at time TO, which precludes CDC circuitry 134 from outputting receiver clocks 114 as respective gated clocks 422. During a channel transition period 502, control circuitry 136 changes ch_sel control 418 to select another channel. At the conclusion of transition period 502, control circuitry 136 activates clk_gate control 420 at time T1, which controls CDC circuitry 134 to output receiver clocks 114 as respective gated clocks 422.

As control circuitry 136 de-activates ch_sel control 418 at time TO and/or activates ch_sel control 418 at time T1, data multiplexer circuitry 428 may output a spurious glitch on internal data 146. To preclude propagation of such glitches, CDR system 124 may further include gate circuitry 426 (e.g., a flip-flop) that gates internal data 146 based on internal clock 148. Internal clock 148 is paused or inactive during transition periods 502, which disables gate circuitry 426 during transition periods 502.

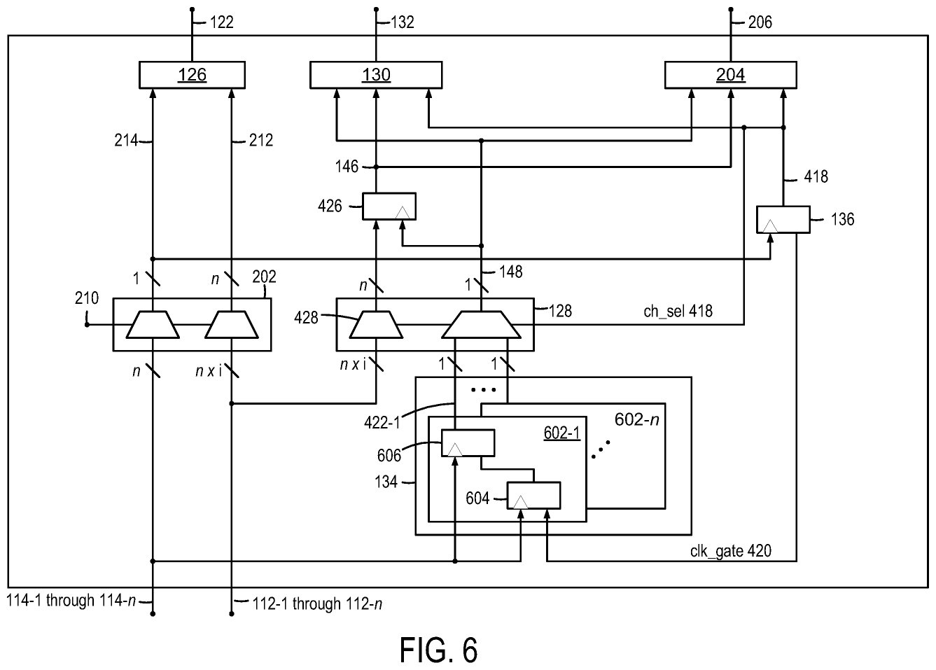

FIG. 6 is a block diagram of CDR system 124, according to an embodiment. In the example of FIG. 6, CDC circuitry 134 includes gating circuits 602-1 through 602-n that gate respective receiver clocks 114. Gating circuit 602-1 includes a synchronizer flip-flop 604 that latches clk_gate control 420 based on receiver clock 114-1. Gating circuit 602-1 further includes a clock latch flip-flop 606 that latches an output of synchronizer flip-flop 604 based on receiver clock 114-1 to provide a gated_clk 422-1. Remaining gating circuits 602 may perform similar functions with respect to remaining receiver clocks 114.

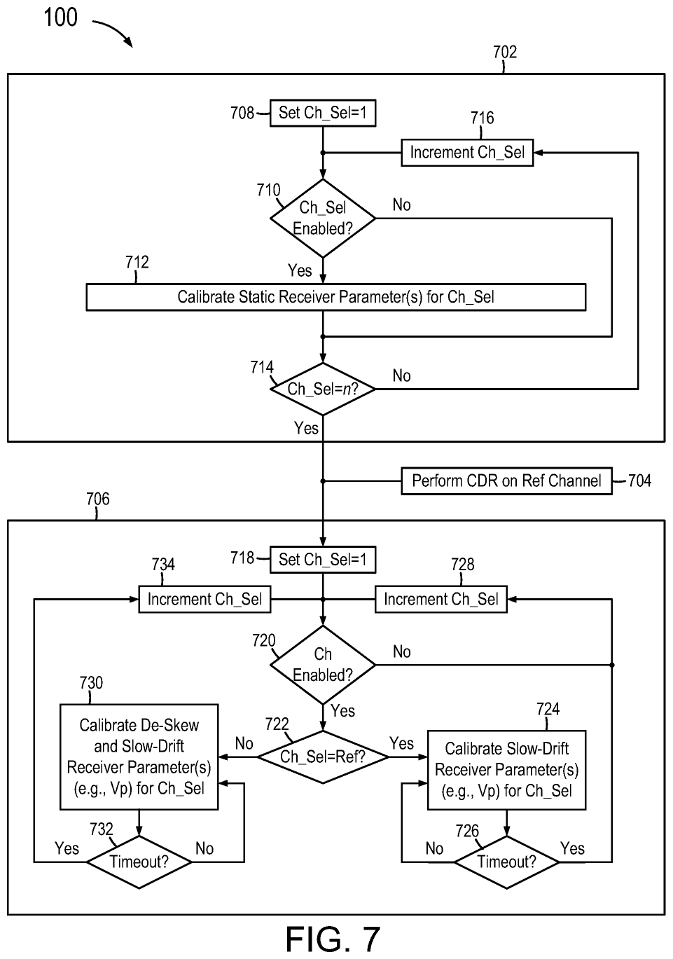

FIG. 7 illustrates a method 700, according to an embodiment. Method 700 is described below with reference to receiver system 102. Method 700 is not, however, limited to the example of receiver system 102.

Method 700 includes a time-interleaved static parameter calibration phase 702 directed to all enabled channels of the multi-channel receiver system, followed by clock and data recovery 704 with respect to a reference one of the channels, and data recovery with respect to remaining channels and time-interleaved adaptive parameter calibration at 706, which may be instituted when the frequency of reference clock 120 is locked to the frequency of the reference clock of transmitter 107.

At 708, control circuitry 136 initializes ch_sel control 144 to a value or state corresponding to a first one of the channels (e.g., receiver circuit 110-1). The first channel need not be the reference channel.

At 710, if the first channel is enabled, processing proceeds to 712, where control circuitry 136 issues or outputs ch_sel control 144. Control circuitry 136 may de-activate clk_gate control 420 prior to issuing ch_sel control 144, and may re-activate clk_gate control 420 following transition period 502.

Based on ch_sel control 144, time-interleaving circuitry 128 outputs data 112-1 and receiver clock 114-1 as internal data 146 and internal clock 148, and time-interleave calibration circuitry 204 determines a static parameter(s) (e.g., CFOK code 314-1) for receiver circuit 110-1 based on internal data 146 and internal clock 148 (i.e., data 112-1 and receiver clock 114-1).

Returning to 710, if the selected channel is not enabled, 712 is bypassed.

At 714, if any channels remain to be considered for static parameter calibration, proceeds to 716, where control circuitry 136 sets or increments ch_sel control 144 to a value or state corresponding to second channel (e.g., receiver circuit 110-2). When all channels have been considered for static parameter determination, processing proceeds to 704.

At 704, reference CDR circuit 126 performs clock and data recovery based on reference channel data 212 and reference channel clock 214. When the frequency of reference clock 120 is locked to the frequency of the reference clock of transmitter 107, processing at 706 commences, and reference CDR circuit 126 continues performing clock and data recovery based on reference channel data 212 and reference channel clock 214.

At 718, control circuitry 136 initializes ch_sel control 144 to a value or state corresponding to a first one of the channels (e.g., receiver circuit 110-1). The first channel need not be the reference channel.

At 720, if the first channel is enabled, processing proceeds to 722. Otherwise, processing proceeds to 728, where control circuitry 136 sets or increments ch_sel control 144 to a value or state corresponding to the second channel (e.g., receiver circuit 110-2).

At 722, if the first channel is the reference channel, processing proceeds to 724, where control circuitry 136 issues or outputs ch_sel control 144. Control circuitry 136 may de-activate clk_gate control 420 prior to issuing ch_sel control 144, and may re-activate clk_gate control 420 following transition period 502.

Based on ch_sel control 144, time-interleaving circuitry 128 outputs data 112-1 and receiver clock 114-1 as internal data 146 and internal clock 148, and time-interleave calibration circuitry 204 determines an adaptive (e.g., slow drift) parameter (e.g., Vp code 316-1) for receiver circuit 110-1 based on internal data 146 and internal clock 148. Time-interleave calibration circuitry 204 may repeatedly determine the adaptive parameter for an allotted period of time. The allotted period of time may equal an available period of time divided by n. When the allotted period of time expires at 726, time-interleave calibration circuitry 204 saves the most recent state of the adaptive parameter determined for the first channel at 724, in a respective one of registers 412. Processing then proceeds to 728.

At 728, control circuitry 136 sets or increments ch_sel control 144 to a value or state corresponding to a second channel (e.g., receiver circuit 110-2). Processing then returns to 720.

Returning to 722, if the first channel is not the reference channel, processing proceeds to 730, where control circuitry 136 issues or outputs ch_sel control 144. Control circuitry 136 may de-activate clk_gate control 420 prior to issuing ch_sel control 144, and may re-activate clk_gate control 420 following transition period 502.

Based on ch_sel control 144, time-interleaving circuitry 128 outputs data 112-1 and receiver clock 114-1 as internal data 146 and internal clock 148, and time-interleave calibration circuitry 204 determines the adaptive parameter (e.g., Vp code 316-1) for receiver circuit 110-1 based on internal data 146 and internal clock 148. In addition, time-interleave de-skew circuitry 130 determines time-interleaved phase offset 132-1 for receiver circuit 110-1 based on internal data 146 and internal clock 148. Time-interleave calibration circuitry 204 may repeatedly determine the adaptive parameter, and time-interleave de-skew circuitry 130 may repeatedly determine time-interleaved phase offset 132-1, for an allotted period of time. When the allotted period of time expires at 732, processing proceeds to 734.

At 734, control circuitry 136 sets or increments ch_sel control 144 to a value or state corresponding to the second channel (e.g., receiver circuit 110-2). Time-interleave calibration circuitry 204 may save the most recent state of the adaptive parameter determined for the first channel in a respective one of registers 412. Similarly, time-interleave de-skew circuitry 130 may save the most recent state of time-interleaved phase offset 132-1 determined for the first channel in a respective one of registers 404. Processing then returns to 720.

In subsequent iterations of 724, time-interleave calibration circuitry 204 may retrieve the most recent state of the adaptive parameter determined for a selected channel from a respective one of registers 412.

In subsequent iterations of 730, time-interleave de-skew circuitry 130 may retrieve the most recent state of the time-interleaved phase offset 132 determined for a selected channel from a respective one of registers 404.

FIG. 8 is a block diagram of receiver system 102, according to an embodiment. In FIG. 8, receiver system 102 includes 16 receiver circuits 110 that output digitized data and error on a data and error bus 802, which is than de-serialized, multiplexed, and synchronized prior to CDR system 124. The data and error may be de-serialized in stages. For example, and without limitation, receiver circuit 110-1 may include a de-serializer circuit 804 that de-serializes to a time period 8T of 8 input symbols (1T=1 symbol period) domain. The 8T de-serialized data and error may be further de-serialized to a 32T domain by a de-serializer circuit 806, and then to a 64T domain by a de-serializer circuit 808. All channels of the data bus and error bus may be multiplexed and synchronized before provided to CDR system 124.

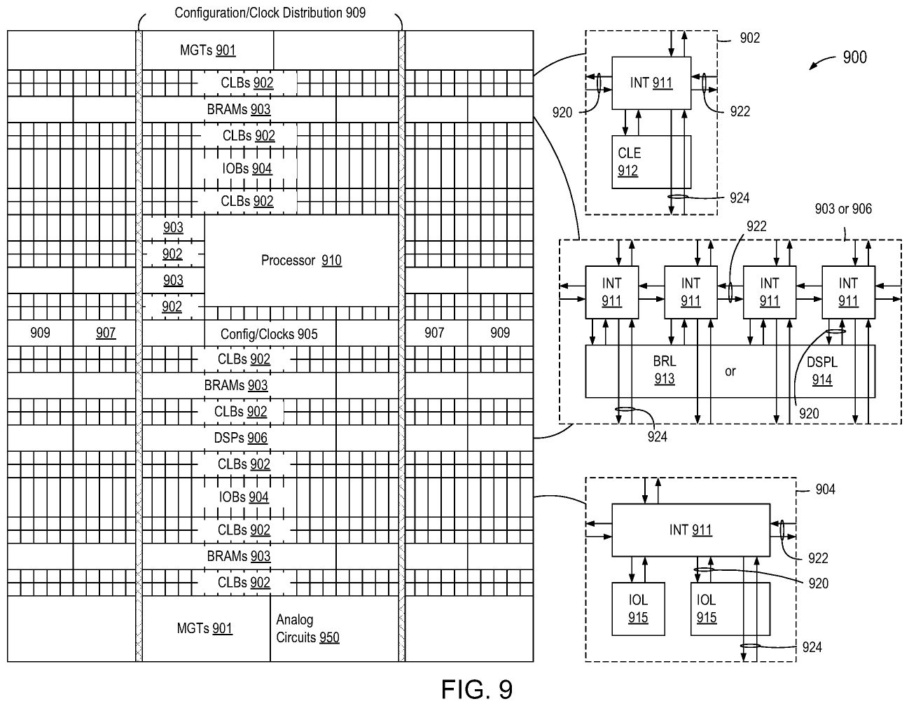

System 100, or a portion thereof, may be provided in an integrated circuit device (e.g., a chip/die or chip set) that includes one or more of a variety of types of configurable circuit blocks, such as described below with reference to FIG. 9. FIG. 9 is a block diagram of configurable circuitry 900, including an array of configurable or programmable circuit blocks or tiles, according to an embodiment. The example of FIG. 9 may represent a field programmable gate array (FPGA) and/or other IC device(s) that utilizes configurable interconnect structures for selectively coupling circuitry/logic elements, such as complex programmable logic devices (CPLDs).

In the example of FIG. 9, the tiles include multi-gigabit transceivers (MGTs) 901, configurable logic blocks (CLBs) 902, block random access memory (BRAM) 903, input/output blocks (IOBs) 904, configuration and clocking logic (Config/Clocks) 905, digital signal processing (DSP) blocks 906, specialized input/output blocks (I/O) 907 (e.g., configuration ports and clock ports), and other programmable logic 908, which may include, without limitation, digital clock managers, analog-to-digital converters, and/or system monitoring logic. The tiles further includes a dedicated processor 910.

One or more tiles may include a programmable interconnect element (INT) 911 having connections to input and output terminals 920 of a programmable logic element within the same tile and/or to one or more other tiles. A programmable INT 911 may include connections to interconnect segments 922 of another programmable INT 911 in the same tile and/or another tile(s). A programmable INT 911 may include connections to interconnect segments 924 of general routing resources between logic blocks (not shown). The general routing resources may include routing channels between logic blocks (not shown) including tracks of interconnect segments (e.g., interconnect segments 924) and switch blocks (not shown) for connecting interconnect segments. Interconnect segments of general routing resources (e.g., interconnect segments 924) may span one or more logic blocks. Programmable INTs 911, in combination with general routing resources, may represent a programmable interconnect structure.

A CLB 902 may include a configurable logic element (CLE) 912 that can be programmed to implement user logic. A CLB 902 may also include a programmable INT 911.

A BRAM 903 may include a BRAM logic element (BRL) 913 and one or more programmable INTs 911. A number of interconnect elements included in a tile may depends on a height of the tile. A BRAM 903 may, for example, have a height of five CLBs 902. Other numbers (e.g., four) may also be used.

A DSP block 906 may include a DSP logic element (DSPL) 914 in addition to one or more programmable INTs 911. An IOB 904 may include, for example, two instances of an input/output logic element (IOL) 915 in addition to one or more instances of a programmable INT 911. An I/O pad connected to, for example, an I/O logic element 915, is not necessarily confined to an area of the I/O logic element 915.

In the example of FIG. 9, config/clocks 905 may be used for configuration, clock, and/or other control logic. Vertical columns 909 may be used to distribute clocks and/or configuration signals.

A logic block (e.g., programmable of fixed-function) may disrupt a columnar structure of configurable circuitry 900. For example, processor 910 spans several columns of CLBs 902 and BRAMs 903. Processor 910 may include one or more of a variety of components such as, without limitation, a single microprocessor to a complete programmable processing system of microprocessor(s), memory controllers, and/or peripherals.

In FIG. 9, configurable circuitry 900 further includes analog circuits 950, which may include, without limitation, one or more analog switches, multiplexers, and/or de-multiplexers. Analog switches may be useful to reduce leakage current.

FIG. 9 is provided for illustrative purposes. Configurable circuitry 900 is not limited to numbers of logic blocks in a row, relative widths of the rows, numbers and orderings of rows, types of logic blocks included in the rows, relative sizes of the logic blocks, illustrated interconnect/logic implementations, or other example features of FIG. 9.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A system, comprising:
a plurality of receiver circuits configured to sample signals based on respective receiver clocks, wherein the receiver circuits comprise a reference receiver circuit and remaining receiver circuits, and wherein a receiver clock of the reference receiver circuit comprises a reference clock;
a clock and data recovery (CDR) circuit configured to control a phase of the reference clock based on outputs of the reference receiver circuit; and
time-multiplexed de-skew circuitry configured to determine time-multiplexed phase offsets for the remaining receiver circuits based on time-multiplexed outputs of the remaining receiver circuits;
wherein the remaining receiver circuits are further configured to phase-shift the reference clock based on the respective time-multiplexed phase offsets to provide the respective receiver clocks.

2. The system of claim 1, further comprising:
reference channel selection circuitry configured to select one of the receiver circuits as the reference receiver circuit.

3. The system of claim 1, wherein the time-multiplexed de-skew circuitry is further configured to determine the time-multiplexed phase offsets for enabled ones of the remaining receiver circuits.

4. The system of claim 1, further comprising:
time-multiplexed calibration circuitry configured to determine time-multiplexed channel-specific parameters for the receiver circuits based on time-multiplexed outputs of the receiver circuits.

5. The system of claim 4, wherein the calibration circuitry is further configured to determine the channel-specific parameters for enabled ones of the receiver circuits.

6. The system of claim 1, wherein outputs of the receiver circuits comprise the receiver clocks, and wherein the system further comprises:
first time-interleaving circuitry configured to time-interleave the receiver clocks output from the receiver circuits based on a channel select control; and
clock domain crossing (CDC) circuitry configured to halt the receiver clocks output from the receiver circuits during transitions of the channel select control.

7. The system of claim 6, further comprising:
second time-interleaving circuitry configured to time-interleave data output from the receiver circuits based on the channel select control; and
glitch control circuitry configured to halt an output of the second time-interleaving circuitry during the transitions of the channel select control.

8. A method, comprising:
extracting data from a plurality of signals with respective receiver circuits based on respective receiver circuit clocks, wherein the receiver circuits comprise a reference receiver circuit and remaining receiver circuits, and wherein a receiver clock of the reference receiver circuit comprises a reference clock;
controlling a frequency of the reference clock based on outputs of the reference receiver circuit;
determining time-multiplexed phase offsets for the remaining receiver circuits based on time-multiplexed outputs of the remaining receiver circuits; and
phase-shifting the reference clock for the remaining receiver circuits based on the respective phase offsets to provide the respective receiver clocks.

9. The method of claim 8, further comprising:
selecting one of the receiver circuits as the reference receiver circuit.

10. The method of claim 8, wherein the determining time-multiplexed phase offsets comprises:
determining the time-multiplexed phase offsets for enabled ones of the remaining receiver circuits.

11. The method of claim 8, further comprising:
determining time-multiplexed channel-specific parameters for the receiver circuits based on time-multiplexed outputs of the receiver circuits.

12. The method of claim 11, wherein the determining time-multiplexed channel-specific parameters comprises:
determining the channel-specific parameters for enabled ones of the receiver circuits.

13. The method of claim 8, wherein outputs of the receiver circuits comprise the receiver clocks, and the method further comprising:
time-interleaving the receiver clocks output from the receiver circuits based on a channel select control; and
halting the receiver clocks output from the receiver circuits during transitions of the channel select control.

14. The method of claim 13, further comprising:
time-interleaving data output from the receiver circuits based on the channel select control; and
halting the time-interleaving data during the transitions of the channel select control.

15. A system, comprising:
a first integrated circuit (IC) device, comprising a plurality of receiver circuits and a clock and data recovery (CDR) system, wherein,
the receiver circuits are configured to sample signals based on respective receiver clocks, the receiver circuits comprise a reference receiver circuit and remaining receiver circuits, and a receiver clock of the reference receiver circuit comprises a reference clock,
the CDR system comprises a CDR circuit configured to control a phase of the reference clock based on outputs of the reference receiver circuit, and time-multiplexed de-skew circuitry configured to determine time-multiplexed phase offsets for the remaining receiver circuits based on time-multiplexed outputs of the remaining receiver circuits, and
the remaining receiver circuits are further configured to phase-shift the reference clock based on the respective time-multiplexed phase offsets to provide the respective receiver clocks; and
a second IC device configured to receive outputs of the receiver circuits.

16. The system of claim 15, wherein the first IC device further comprises:
multi-stage de-serializer circuitry configured to de-serialize data outputs of the receiver circuits in stages, and to provide de-serialized outputs to the CDR system and to the second IC device.

17. The system of claim 16, wherein the first and second IC devices comprise respective first and second chip-to-chip interface circuitry configured to interface with one another over a fiber optic link, wherein the first and second chip-to-chip interface circuitry comprise respective parallel physical layer circuitry.

18. The system of claim 15, wherein the first IC device further comprises:
time-multiplexed calibration circuitry configured to determine time-multiplexed channel-specific parameters for the receiver circuits based on time-multiplexed outputs of the receiver circuits.

19. The system of claim 15, wherein the first IC device further comprises:
reference channel selection circuitry configured to select one of the receiver circuits as the reference receiver circuit.

20. The system of claim 15, wherein the time-multiplexed de-skew circuitry is further configured to determine the time-multiplexed phase offsets for enabled ones of the remaining receiver circuits.
